(19) United States
(12) Patent Application Publication
(10) Pub. No.: US 2003/0210353 A1
(43) Pub. Date: Nov. 13, 2003

(54) Apparatus for receiving digital broadcasting and method thereof

(75) Inventors: Won-Sik Jeong, Suwon-city (KR); Jae-Young Shim, Seoul (KR)

Correspondence Address: SUGHRUE MION, PLLC, 2100 Pennsylvania Avenue, NW, Washington, DC, 20037-3213, US

(73) Assignee: SAMSUNG ELECTRONICS CO., LTD.

(21) Appl. No.: 10/386,115

(22) Filed: Mar. 12, 2003

(30) Foreign Application Priority Data
Mar. 13, 2002 (KR) 2002-13413

(51) Int. Cl. H04N 5/445; H04N 5/268

(52) U.S. Cl. 348/705; 348/563

(57) ABSTRACT

Disclosed is an apparatus for receiving digital broadcasting and method thereof. Program guidance data extracted from a broadcasting signal, is stored in a storing unit. A channel detecting unit detects whether a reception channel through which the broadcasting signal is received, is changed. A display information generating unit generates program information regarding a program received through the changed reception channel on the basis of the program guidance data according to a predetermined display item upon change of the reception channel. A displaying unit outputs the program information according to a predetermined displaying method. User convenience is improved, for a user can obtain information regarding the program received through the changed channel upon change of a channel without separate operation.

### BACKGROUND OF THE INVENTION

1. Field of the Invention

The present invention relates to an apparatus for receiving digital broadcasting and method thereof, and more particularly to an apparatus for receiving digital broadcasting and method thereof capable of outputting program guidance data on a portion of a screen. The present application is based on Korean Patent Application No. 202-13413, filed Mar. 13, 2002, which is incorporated herein by reference.

2. Background of the Related Art

Digital broadcasting provides program guidance information for each channel together with a broadcasting signal. The received program guidance information is stored in a separate storing unit and output on a screen based on user selection. A general digital broadcasting receiver, however, displays the program guidance information on the entire screen, so there is a disadvantage in that a viewer cannot watch a program while the program guidance information is being displayed.

For a method to resolve such problem, there exists a Korean Patent Laying Open No. 1999-0075944 titled “Method for displaying a program guidance screen in a satellite broadcasting receiver”, which suggests a method for displaying program guidance information on a portion of a screen. In such method, a viewer can watch a program presently being received while the program guidance information is being output, but as all the programs broadcasted for each channel are output, it is difficult to satisfy various desires of an audience.

A related art program guidance method does not consider the fact that information required by an audience is information about a program to be broadcast after termination of a program presently being watched. Further, according to a related art program guidance method, a user is inconvenienced by having to keep in mind separately a channel number and broadcasting time of a program desired to be watched next.

In the meantime, a related art TV has a function of outputting information about a channel whose broadcasting signal is presently being received upon supply of a power supply or change of a channel. But, as the output channel information includes only a channel number, if a user wants to get more detailed information about the program being received, the user must operate a remote controller or an input pad, and select a program guidance mode, causing inconvenience.

### SUMMARY OF THE INVENTION

An object of the invention is to solve at least the above problems and/or disadvantages and to provide at least the advantages described hereinafter.

Accordingly, one object of the present invention is to solve the foregoing problems by providing an apparatus for receiving digital broadcasting and a method thereof capable of selectively outputting guidance information for a program received through a channel upon supply of power or change of a channel.

Another object of the present invention, is to provide an apparatus for receiving digital broadcasting and a method thereof capable of selectively outputting guidance information for a program to be broadcast after a program presently being watched, and of making a reservation for a specific program among guided programs.

The foregoing and other objects and advantages are realized by an apparatus for receiving digital broadcasting including a storing unit for storing program guidance data extracted from a broadcasting signal, a channel detecting unit for detecting whether a reception channel through which the broadcasting signal is received is changed, a display information generating unit for generating program information regarding a program received through the changed reception channel on the basis of the program guidance data in accordance with a predetermined displaying item upon change of the reception channel, and a displaying unit for outputting the program information according to a predetermined displaying method.

Here, the program information includes at least two channel numbers and program titles. Preferably, an apparatus for receiving digital broadcasting further includes a display controlling unit for controlling the displaying unit to display the display information according to the displaying method selected by a user.

Preferably, an apparatus for receiving digital broadcasting further includes a power supply detecting unit for detecting whether a power supply is provided, and wherein the display information generating unit generates the program information if it is detected that the power supply is provided.

Preferably, an apparatus for receiving digital broadcasting further includes a control unit for providing the display information generating unit with a control signal for generating next program information regarding the program, that will be broadcast within a predetermined time from the termination time of the program received through the reception channel upon arrival of a predetermined set time.

In that case, the display information generating unit includes a time checking unit for checking whether the present time conforms to the set time and a display information extracting unit for generating next program information on the basis of the program guidance data according to the displaying item if the present time reaches the set time.

Preferably, an apparatus for receiving digital broadcasting further includes a channel changing unit for changing the reception channel into a channel through which a specific program is received at the beginning of the specific program if a reservation command for the specific program included in the next program information is received from a user. Also, the apparatus preferably includes a setting unit for receiving the set time and the displaying item from a user.

The displaying method includes at least either of a first method in which a channel number and a program title for each channel are scrolled on a predetermined portion of the displaying unit, or a second method in which the channel number and the program title for each channel are displayed sequentially on a predetermined portion of the displaying unit for a predetermined period of time.

In the meantime, a method for receiving a digital broadcast according to another object of the present invention includes the step of storing program guidance data extracted from a received broadcasting signal, the step of detecting whether a reception channel is changed, the step of generating program information regarding a program received through the changed reception channel on the basis of the program guidance data in accordance with a predetermined displaying item upon change of the reception channel, and the step of outputting the program information according to a predetermined displaying method.

Preferably, the program information includes at least two channel numbers and program titles.

Preferably, the method further includes the step of detecting whether a power supply is provided, and the step of generating program information is carried out if it is detected that the power supply is provided.

Preferably, the method further includes the steps of generating next program information regarding the program, that would be broadcasted within a predetermined time from termination time of the program received through the reception channel upon arrival of a predetermined set time; and displaying the next program information according to the displaying method.

The method further includes the step of changing the reception channel into a channel through which a specific program is received at the time the specific program begins if a reservation command for the specific program included in the next program information is received from a user.

Here, the displaying method includes at least either of a first method in which a channel number and a program title for each channel are scrolled on a predetermined portion of a displaying device, or a second method in which the channel number and the program title for each channel are displayed sequentially on a predetermined portion of the displaying device for a predetermined period of time.

Preferably, the method further includes the step of receiving the set time and the displaying item from a user before the storing step.

### BRIEF DESCRIPTION OF THE DRAWINGS

The invention will be described in detail with reference to the following drawings in which like reference numerals refer to like elements wherein:

FIG. 1 is a block diagram illustrating construction of a preferred embodiment of an apparatus for receiving digital broadcasting according to the present invention;

FIG. 2 is a drawing illustrating detailed construction of a display information generating unit provided to an apparatus for receiving digital broadcasting according to the present invention;

FIG. 3A and FIG. 3B are drawings illustrating one example of display information displayed on an apparatus for receiving digital broadcasting according to the present invention, respectively;

FIG. 4 is a flowchart illustrating a procedure for performing a method for receiving digital broadcasting according to the present invention; and

FIG. 5 is a flowchart illustrating a detailed procedure for performing a next program guidance function shown in FIG. 4.

### DETAILED DESCRIPTION OF PREFERRED EMBODIMENTS

The following detailed description will present an apparatus for receiving digital broadcasting and method thereof according to a preferred embodiment of the invention with reference to the accompanying drawings.

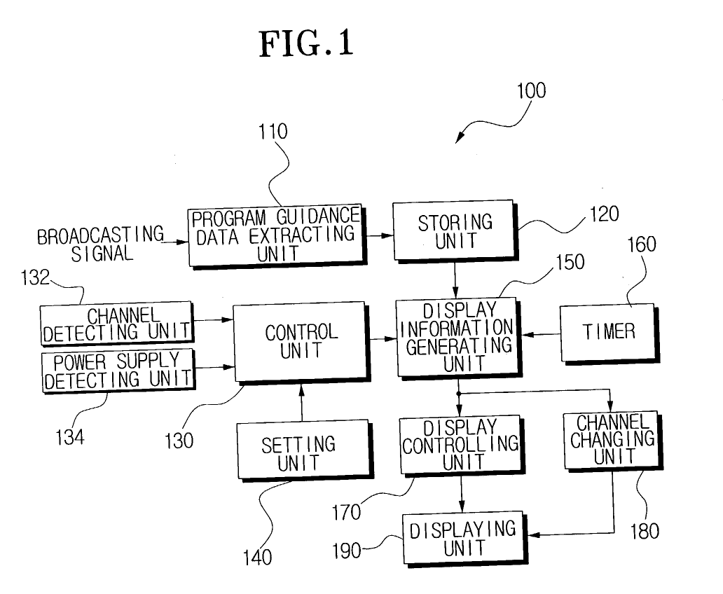

Referring to FIG. 1, an apparatus 100 for receiving digital broadcasting according to the present invention, has a program guidance data extracting unit 110, a storing unit 120, a control unit 130, a channel detecting unit 132, a power supply detecting unit 134, a setting unit 140, a display information generating unit 150, a timer 160, a display controlling unit 170, and a displaying unit 190.

The program guidance data extracting unit 110 extracts program guidance data from a received broadcasting signal. The extracted program guidance data is stored in the storing unit 120.

The channel detecting unit 132 detects a channel through which a broadcasting signal is presently received. The channel detecting unit 132 could check a channel status of a synchronization unit(not shown), detecting a reception channel when a power supply is provided to a digital TV or a channel is changed. The synchronization unit could also be configured to carry out functions of the channel detecting unit 132. The channel detecting unit 132 outputs a reception channel detecting signal including information such as a channel number, to a control unit 130.

The power supply detecting unit 134 detects the power on/off status of the digital TV. If the power is provided to the digital TV, the power supply detecting unit 134 outputs a power supply detecting signal to the control unit 130.

The control unit 130 outputs a controlling signal for generating display information regarding the program received through a reception channel, to the display information generating unit 150, if a reception channel detecting signal is received from the channel detecting unit 132 indicating a channel change. Additionally, the control unit 130 also carries out the same operation in case that a power supply detecting signal is received from the power supply detecting unit 132 indicating that power is supplied to the TV.

In the meantime, in case that a next program guidance function is set, the control unit 130 outputs a controlling signal for generating display information regarding a program that will be broadcast within a predetermined period of time from the termination time of a program presently watched, to the display information generating unit 150, upon arrival of a set time previously set. Further, the control unit 130 controls operations of the digital TV and other elements.

The display information generating unit 150 generates display information regarding the program received through the reception channel on the basis of program guidance data according to a displaying item previously set. A user could set or change the displaying item using the setting unit 140.

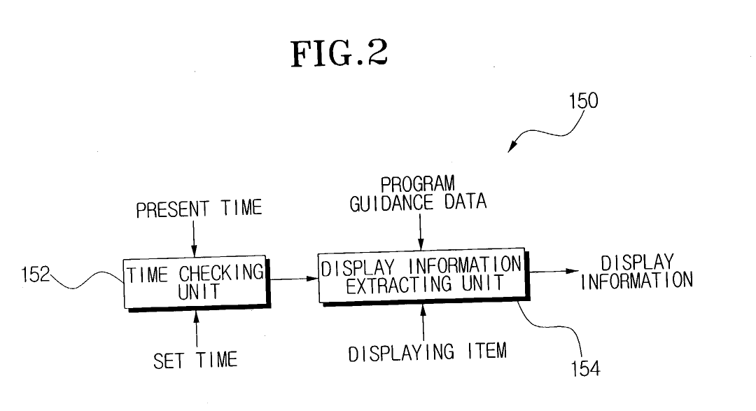

In the meantime, in case that a next program guidance function is set to be performed, the display information generating unit 150 generates display information regarding a program that will be broadcast within a predetermined period of time from the termination time of a program presently watched, on the basis of the program guidance data according to a displaying item previously set if a present time reaches a set time. In FIG. 2, a detailed construction of the display information generating unit 150 is illustrated. Referring to FIG. 2, the display information generating unit 150 includes a time checking unit 152 and a display information extracting unit 154. The time checking unit 152 checks whether a present time received from a timer 160 conforms to a set time. The display information extracting unit 154 generates display information on the basis of the program guidance data according to a displaying item if the present time reaches the set time.

The set time is a time received through the setting unit 140 from a user, namely, a time before a predetermined time from the termination time of the program presently watched by a user. For example, in case that the termination time of the program watched by a user is 9:00 p.m., the set time could be set to 8:55 p.m., or 8:50 p.m. In the meantime, it is preferable that a user could input the time in the form of five minutes or ten minutes. In that case, the set time is the time where a time input by a user is subtracted from the termination time, 9:00 p.m., namely, the set time becomes 8:55 p.m. or 8:50 p.m., respectively, when the user inputs five minutes or ten minutes. Further, preferably a predetermined basic value is set so that display information is displayed at a predetermined time (for example, ten minutes) after the termination of the program watched even when the set time is not input by a user.

In the meantime, the display information generated by the display information extracting unit 154, is generated only for the program that will be broadcast within a predetermined period of time from the termination of the program presently watched. Namely, it is preferable that a searching object is limited by a criterion of a predetermined period of time, such as a program that would begin in five minutes or ten minutes after the termination of the program presently watched. Such searching range is possibly adjusted by a user and a predetermined value could be used for an initial value.

The displaying item includes a program title, a beginning time and a termination time of a program, and a brief description of a program for each channel that will be broadcast after the termination of the program presently watched by a user. A user could set an item desired to be checked through the setting unit 140 among the displaying items described above. Therefore, the display information is information generated from the program guidance data according to the item set by a user.

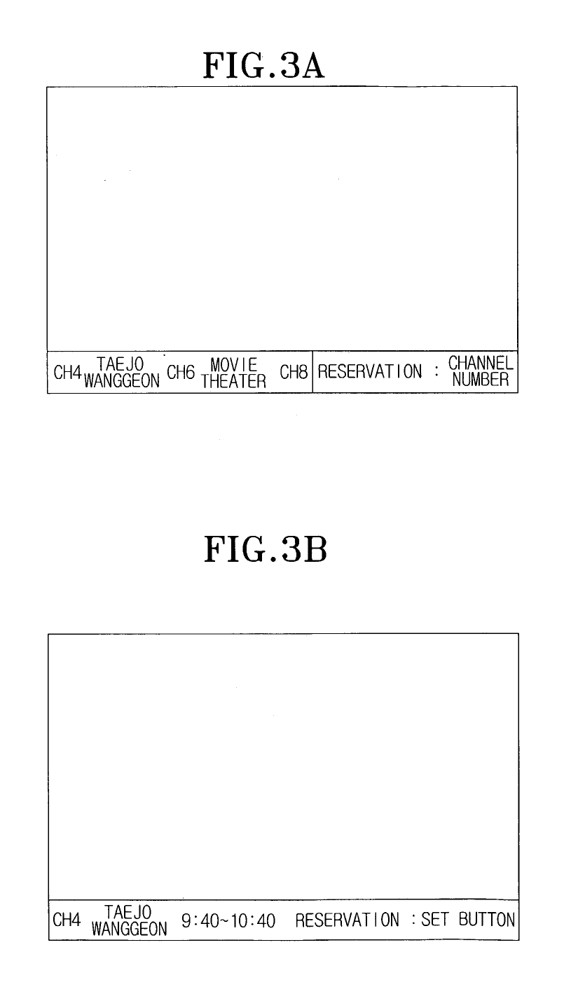

The display controlling unit 170 controls the displaying unit 190 to display the display information generated from the display information generating unit 150 according to a displaying method selected by a user. The displaying method may be a first method where a channel number and a program title included in the display information, are scrolled on a predetermined portion of the displaying unit 190, or a second method where a channel number and a program title, a beginning and termination time of a program, and a brief description of a program included in the display information, are displayed sequentially for a predetermined period of time on a predetermined portion of the displaying unit 190, or a third method where a channel number and a program title included in the display information are output in the form of a pop-up window on a predetermined portion of the displaying unit 190. FIG. 3A is a drawing illustrating a screen on which the display information is displayed according to the first method, and FIG. 3B is a drawing illustrating a screen on which the display information is displayed according to the second method. Also, for the displaying item and the displaying method, predetermined values are set for initial values so that generation and displaying operations of the display information can be carried out even when set values are not input separately by a user.

The channel changing unit 180 changes to a channel through which a specific program is received at the termination of the program presently being watched, or at the time of the beginning of the specific program if a reservation command for the specific program included in the display information is received from a user. The channel changing unit 180 could receive the reservation command through various methods from a user. For example, in case that a channel number and a program title included in the display information, are scrolled from the right side to the left side on the lower end, the channel changing unit may adopt a method where a reservation for a relevant channel is made upon input of a desired channel number through input means such as a remote controller by a user (FIG. 3A).

Also, in case that each channel number and program title, a beginning time and termination time of a program, and a brief description of a program included in the display information, are displayed sequentially for a predetermined period of time, the channel changing unit may adopt a method where a user inputs a channel number for which a reservation will be made through input means such as a remote controller. Alternatively, a reservation for a relevant channel may be made if a specific button (for example, a set button) is pressed (FIG. 3B).

The displaying unit 190 is means for outputting an image, like a cathode-ray tube and a liquid crystal display.

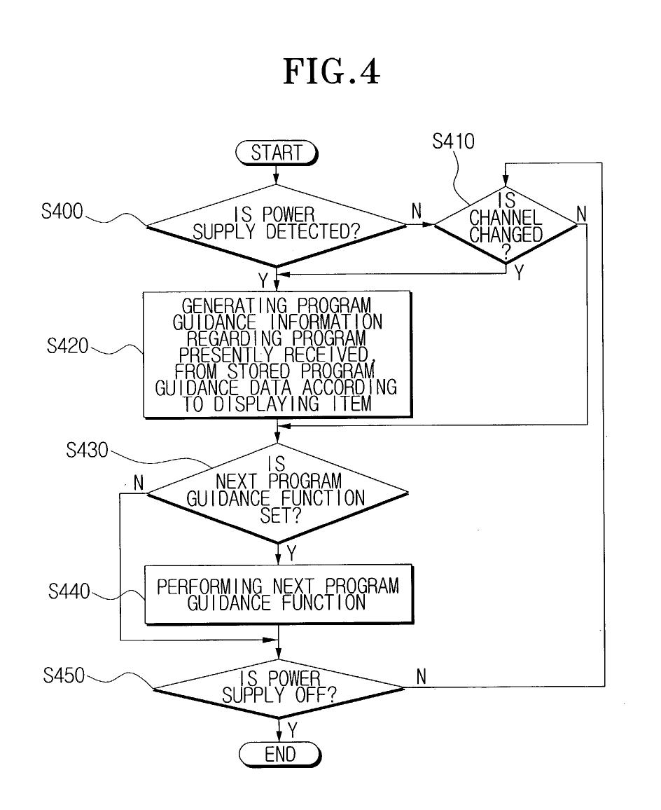

FIG. 4 is a flowchart illustrating a procedure for performing a method of another embodiment of the invention, where the method is for receiving digital broadcasting.

Referring to FIG. 4, the power supply detecting unit 134 detects whether the power supply is provided (S400). The power supply detecting unit 134 outputs a power supply detecting signal to the control unit 130 upon operation of a power supply button provided to the digital TV, or a power supply button provided to the remote controller by a user. The display information generating unit 150 generates display information regarding the program received through a present channel (S420).

In the meantime, the display information is generated even if a channel change by a user is detected while the power supply is being provided (S410). Generating operation of the display information generating unit 150 according to detection of the power supply provided and detection of the channel change, is controlled by the control unit 130.

In case that a next program guidance function is set (S430), the next program guidance function is performed (S440). If the next program guidance function is not set, however, the status of the power supply is checked(S450), and the steps of S410 through S440 are performed repeatedly until the power supply becomes off.

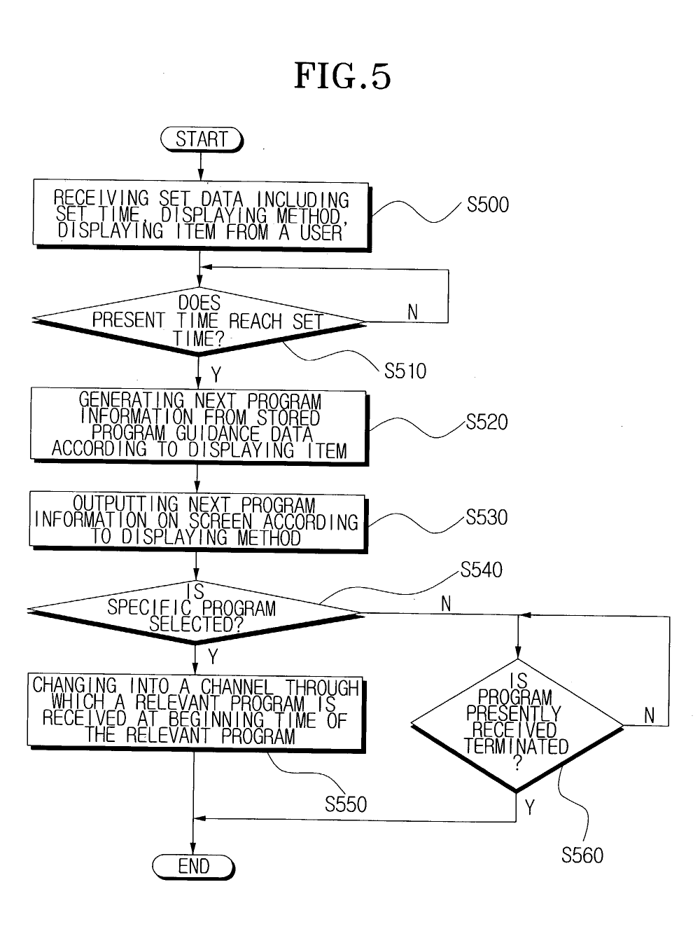

FIG. 5 is a flowchart illustrating a detailed procedure for performing the next program guidance function.

Referring to FIG. 5, a user inputs set data including a set time, a display item, a displaying method, etc. (S500). The time checking unit 152 checks whether a present time reaches a set time set by a user (S510). If the present time and the set time are the same, the display information extracting unit 154 generates display information from the stored program guidance data according to the displaying item (S520). The generated information is output to the displaying unit 180 according to a displaying method (S530). Here, descriptions for the set time, the displaying item, and the displaying method, are omitted, for they are the same as the foregoing.

In the meantime, a user could make a reservation for a specific program before termination of a program presently watched on the basis of the display information provided (S540). The channel changing unit 180 changes to a channel through which a relevant program is received, at the termination time of the present program or at the beginning time of the relevant program if a reservation command for the relevant program is input by a user (S550). A user could input the reservation command until the termination time of the present program (S560). If the reservation command is input by a user, the display information, a next program guidance information, is preferably not displayed any more. But, if a user cancels the reservation command before termination of the present program, the display information is displayed again on the displaying unit 180.

According to the apparatus for receiving digital broadcasting and method of the present invention, there is a significant advantage of being able to obtain information regarding a program presently received upon supply of the power supply and change of the channel. Also, a user can obtain information about a program that will be broadcast after the termination time of the program presently watched for each channel, through the next program guidance information displayed on a portion of the screen without separate operation. Further, user convenience is improved, for a user could make a reservation for a program to watch after the termination of the program presently watched on the basis of the next program guidance information.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An apparatus for receiving digital broadcasting, comprising:
a storing unit for storing program guidance data extracted from a broadcasting signal;
a channel detecting unit for detecting whether a reception channel through which the broadcasting signal is received, is changed;
a display information generating unit for generating program information regarding a program received through the changed reception channel on the basis of the program guidance data in accordance with a predetermined displaying item upon change of the reception channel; and
a displaying unit for outputting the program information according to a predetermined displaying method.

2. The apparatus according to claim 1, wherein the program information comprises at least two channel numbers and program titles.

3. The apparatus according to claim 1, further comprising a display controlling unit for controlling the displaying unit to display the program information according to the displaying method selected by a user.

4. The apparatus according to claim 1, further comprising:
a power supply detecting unit for detecting whether a power supply is provided; and
wherein the display information generating unit generates the program information if the power supply is detected to be provided.

5. The apparatus according to claim 1, further comprises a control unit for providing the display information generating unit with a control signal for generating next program information regarding a program that will be broadcast within a predetermined time from a termination time of the program received through the reception channel upon arrival of a predetermined set time.

6. The apparatus according to claim 5, wherein the display information generating unit comprises:
a time checking unit for checking whether present time conforms to the set time; and
a display information extracting unit for generating next program information on the basis of the program guidance data according to the displaying item if the present time reaches the set time.

7. The apparatus according to claim 5, further comprising:
a channel changing unit for changing the reception channel to a channel through which a specific program is received at a time at which the specific program begins if a reservation command for the specific program included in the next program information is received from a user.

8. The apparatus according to claim 5, further comprising:
a display controlling unit for controlling the displaying unit to display the program information according to the displaying method selected by a user.

9. The apparatus according to claim 5, further comprises a setting unit for receiving the set time and the displaying item from a user.

10. The apparatus according to claim 1, wherein the displaying method comprises at least either of a first method in which a channel number and a program title for each channel are scrolled on a predetermined portion of the displaying unit, or a second method in which the channel number and the program title for each channel are displayed sequentially on a predetermined portion of the displaying unit for a predetermined period of time.

11. A method for receiving a digital broadcasting comprising the steps of:
storing program guidance data extracted from a received broadcasting signal;
detecting whether a reception channel is changed;
generating program information regarding a program received through the changed reception channel on the basis of the program guidance data according to a predetermined displaying item upon change of the reception channel; and
outputting the program information according to a predetermined displaying method.

12. The method according to claim 11, wherein the program information comprises at least two channel numbers and program titles.

13. The method according to claim 11, further comprising the step of:
detecting whether a power supply is provided, and
wherein the step of generating program information is carried out if it is detected that the power supply is provided.

14. The method according to claim 11, further comprising the steps of:
generating next program information regarding a program that will be broadcast within a predetermined time from a termination time of the program received through the reception channel upon arrival of a predetermined set time; and
displaying the next program information according to the displaying method.

15. The method according to claim 14, further comprising the step of changing the reception channel into a channel through which a specific program is received at a time at which the specific program begins if a reservation command for the specific program included in the next program information is received from a user.

16. The method according to claim 11, wherein the displaying method comprises at least either of a first method in which a channel number and a program title for each channel are scrolled on a predetermined portion of a displaying device, or a second method in which the channel number and the program title for each channel are displayed sequentially on a predetermined portion of the displaying device for a predetermined period of time.

17. The method according to claim 11, further comprising the step of receiving the set time and the displaying item from a user before the storing step.
